(19) United States
(12) Patent Application Publication
(10) Pub. No.: US 2002/0097928 A1
(43) Pub. Date: Jul. 25, 2002

(54) Self-aligning/centering rotating foil thrust bearing (air film type) utilized in a rotating compressor

(75) Inventors: Michael Swinton, Fallbrook, CA (US); Jan Swinton, Fallbrook, CA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: Capstone Trubine Corporation, Chatsworth, CA (US)

(21) Appl. No.: 09/985,762

(22) Filed: Nov. 6, 2001

Related U.S. Application Data
(60) Provisional application No. 60/246,134, filed on Nov. 6, 2000.

(51) Int. Cl. F16C 32/06

(52) U.S. Cl. 384/103

(57) ABSTRACT

A rotating impeller disc of a rotating compressor is utilized as a thrust bearing (air film type) by clamping a compliant foil member on each side of the rotating impeller disc to cause the foil members to rotate with the impeller disc and relative to fixed bearing surfaces on each side of the rotating impeller disc. The fixed bearing surfaces and compressor housing sections enclose the impeller/foil assembly within a compression chamber. The rotating impeller/foil assembly drags along a layer of fluid on each side of the impeller/foil assembly and is caused to be centered within the compression chamber due to the equalized fluid film pressure build up on either side of the impeller/foil assembly with no external axially alignment device required. The impeller/foil assembly is integrated as a component of the motor shaft of the motor driving the compressor. It is emphasized that this abstract is provided to comply with the rules requiring an abstract which will allow a searcher or other reader to quickly ascertain the subject matter of the technical disclosure. It is submitted with the understanding that it will not be used to interpret or limit the scope or meaning of the claims.

### REFERENCE TO RELATED APPLICATION

This application claims the benefit of priority under 35 USC 119(e) of U.S. Provisional Application No. 60/246,134, filed on Nov. 6, 2000, assigned to the assignee of the present application, which is attached as Exhibit A and is incorporated herein by reference.

### TECHNICAL FIELD

This invention relates to fluid film bearings and, more specifically, to fluid film thrust bearings employing compliant foils attached to the rotating portion of such bearings.

### BACKGROUND OF THE INVENTION

Conventional compliant foil fluid film thrust bearings contain numerous parts, the assembly of which is complex, time consuming and therefore costly. In addition, conventional thrust bearings of this type typically require the use of an impeller made of hard and costly materials.

What is needed is a compliant foil hydrodynamic fluid film thrust bearing having a reduced part count and simplified assembly. For example, there is a need for a compliant foil hydrodynamic fluid film thrust bearing that eliminates the necessity of separately assembling the compliant foil member to stationary bearing surfaces or housing sections by pins or other devices positioned radially outwardly of the impeller disc. In addition, a compliant foil hydrodynamic fluid film thrust bearing that employs an impeller made of softer and less expensive materials is required.

### SUMMARY OF THE INVENTION

In a first aspect, the present invention provides a compliant foil fluid film thrust bearing including:

a thrust disc rotatably supported between a first non-rotating thrust bearing surface and a second non-rotating thrust bearing surface;

a first compliant foil member operably disposed between the thrust disc and the first of non-rotating thrust bearing surface;

a second compliant foil member operably disposed between the thrust disc and the second thrust bearing surface ; and

a mounting structure that attaches the first compliant foil member and the second compliant foil member on the opposing surfaces of thrust disc for rotation therewith.

In another aspect, the present invention provides a turbomachine including:

a thrust disc rotatably supported on a shaft between a first non-rotating thrust bearing surface and a second non-rotating thrust bearing surface;

a first compliant foil member clamped adjacent to a first face of the thrust disc, between said first face and the first non-rotating thrust bearing surface, for rotation with the thrust disc; and

a second compliant foil member clamped adjacent to a second face of the thrust disc, between the second face and said second non-rotating thrust bearing surface, for rotation with the thrust disc.

In another aspect, the present invention provides a method of making a compliant foil fluid thrust bearing comprising the following steps:

rotatably supporting a thrust disc between a first non-rotating thrust bearing surface and a second non-rotating thrust bearing surface;

operably disposing a first compliant foil member between the thrust disc and the first thrust bearing surface;

operably disposing a second compliant foil member between the thrust disc and the second thrust bearing surface; and

mounting the first compliant foil member and the second compliant foil member to the thrust disc for rotation therewith.

In another aspect, the present invention provides a compliant foil fluid film thrust bearing including:

first means for resisting thrust forces rotatably supported between a first non-rotating thrust bearing means and a second non-rotating thrust bearing means;

a first compliant foil means operably disposed between the first means and the first non-rotating thrust bearing means;

a second compliant foil means operably disposed between the first means and the second thrust bearing means; and

second means for mounting the first compliant foil means and the second compliant foil means on the first means for rotation therewith.

In another aspect, the present invention provides a method of using a compliant foil fluid thrust bearing comprising the following steps:

mounting a rotatable thrust disc between a first non-rotating thrust bearing surface and a second non-rotating thrust bearing surface;

operably disposing a first compliant foil member between the thrust disc and the first thrust bearing surface;

operably disposing a second compliant foil member between the thrust disc and the second thrust bearing surface;

mounting the first compliant foil member and the second compliant foil member to the thrust disc; and

rotating the first compliant foil member, the second compliant foil member, and the thrust disc together with respect to the first thrust bearing surface and the second thrust bearing surface.

In another aspect, the present invention provides a method for laterally stabilizing a thrust disc rotatably supported on a shaft between a first non-rotating thrust bearing surface and a second non-rotating thrust bearing surface comprising:

clamping a first compliant foil disc onto a first face of the thrust disc between the first face and the first non-rotating thrust bearing surface; and

clamping a second compliant foil disc onto a second face of the thrust disc between the second face and the second non-rotating thrust bearing surface.

These and other features and advantages of this invention will become further apparent from the detailed description and accompanying figures that follow. In the figures and description, numerals indicate the various features of the invention, like numerals referring to like features throughout both the drawings and the description.

### BRIEF DESCRIPTION OF THE DRAWINGS

Having described the invention in general terms, reference will now be made to the accompanying drawings in which:

FIG. 1A is perspective view, partially in section, of an integrated turbogenerator system.

FIG. 1B is a magnified perspective view, partially in section, of the motor/generator portion of the integrated turbogenerator of FIG. 1A.

FIG. 1C is an end view, from the motor/generator end, of the integrated turbogenerator of FIG. 1A.

FIG. 1D is a magnified perspective view, partially in section, of the combustor-turbine exhaust portion of the integrated turbogenerator of FIG. 1A.

FIG. 1E is a magnified perspective view, partially in section, of the compressor-turbine portion of the integrated turbogenerator of FIG. 1A.

FIG. 2 is a block diagram schematic of a turbogenerator system including a power controller having decoupled rotor speed, operating temperature, and DC bus voltage control loops.

FIG. 3 is a sectional view of a first exemplary embodiment.

FIG. 4 is a sectional view of a second exemplary embodiment.

FIG. 5 is a schematic of an embodiment of a four stage compressor according to an exemplary embodiment with each stage driven by its own motor.

FIG. 6 is a schematic of another embodiment of a four stage compressor according to an exemplary embodiment with the first two stages driven by one motor and the second two stages driven by a second motor.

### DETAILED DESCRIPTION OF THE PREFERRED EMBODIMENT(S)

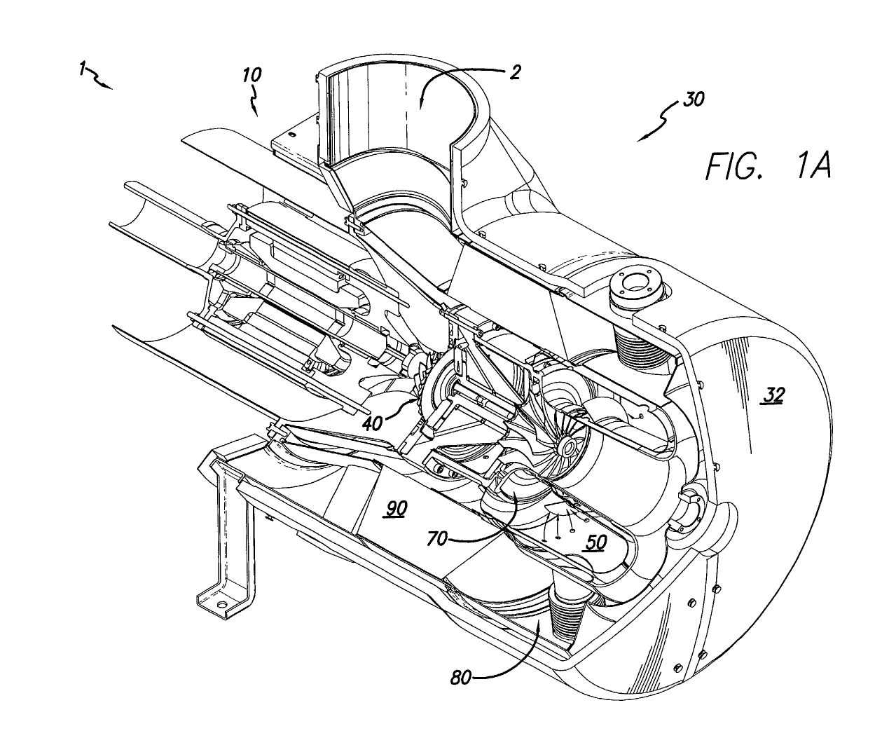

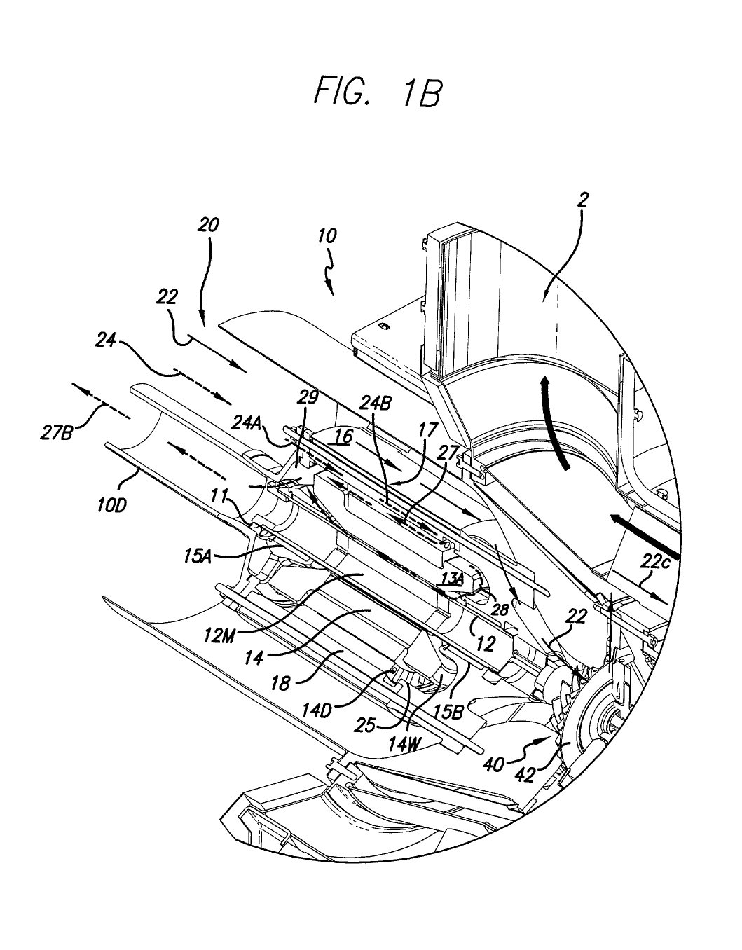

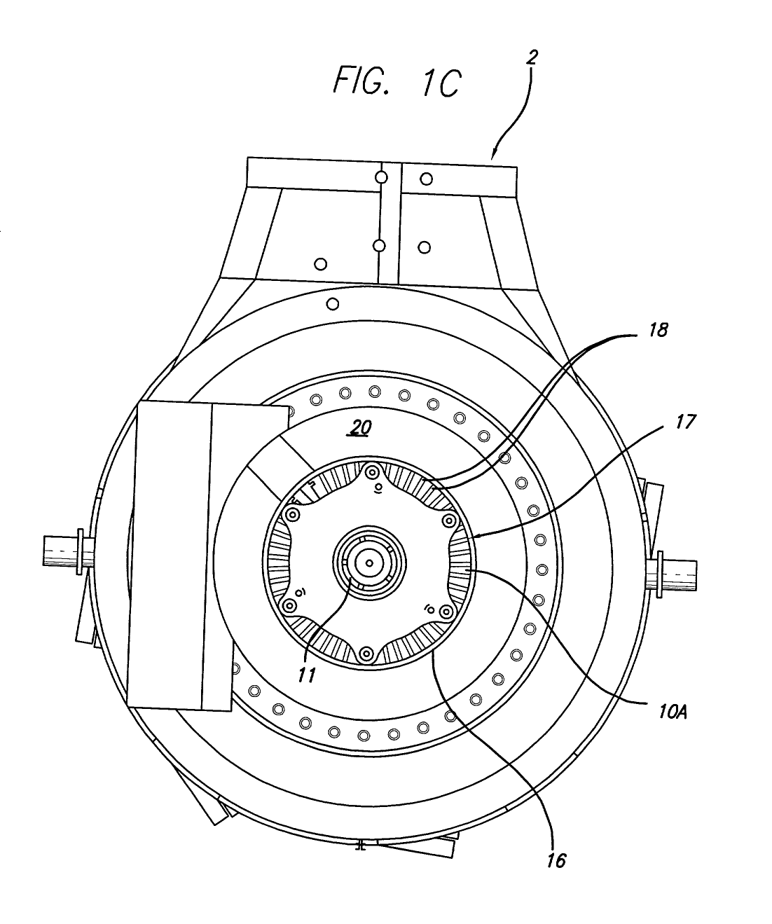

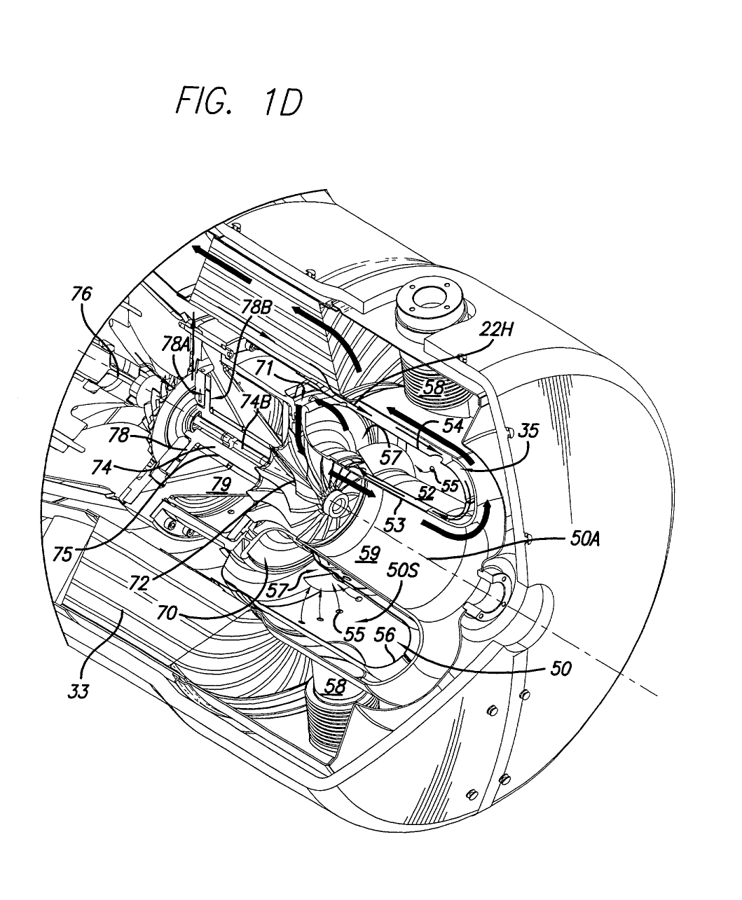

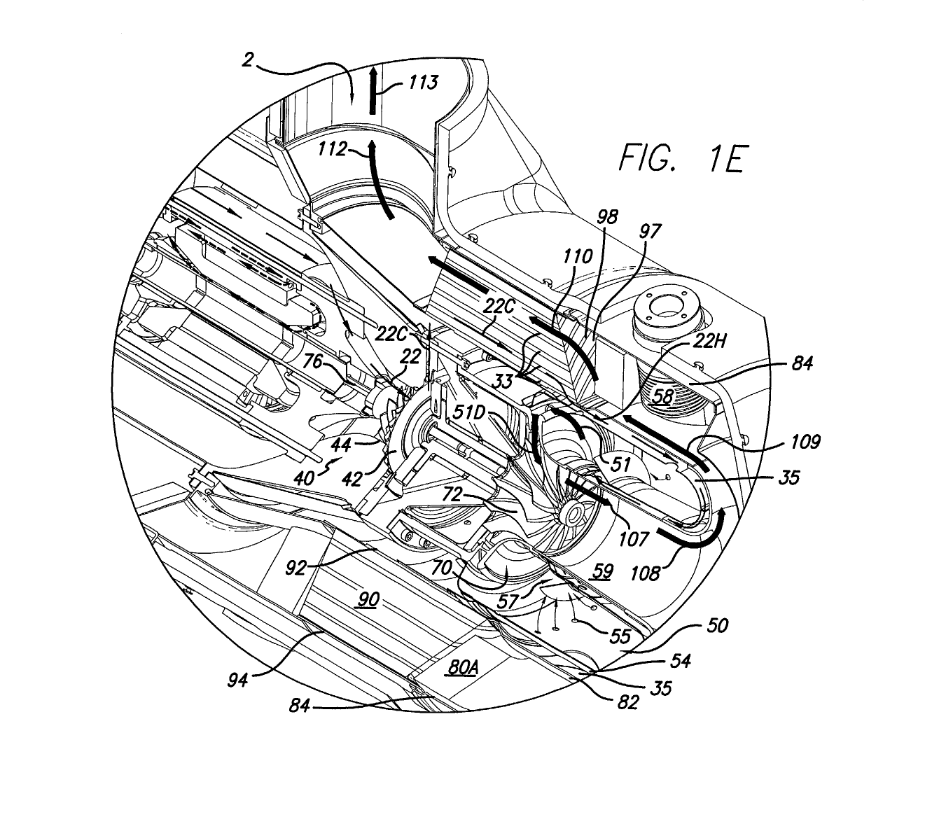

With reference to FIG. 1A, an integrated turbogenerator 1 according to the present disclosure generally includes motor/generator section 10 and compressor-turbine section 30. Compressor-turbine section 30 includes exterior can 32, compressor 40, combustor 50 and turbine 70. A recuperator 90 may be optionally included.

Referring now to FIG. 1B and FIG. 1C, in a currently preferred embodiment of the present disclosure, motor/generator section 10 may be a permanent magnet motor generator having a permanent magnet rotor or sleeve 12. Any other suitable type of motor generator may also be used. Permanent magnet rotor or sleeve 12 may contain a permanent magnet 12M. Permanent magnet rotor or sleeve 12 and the permanent magnet disposed therein are rotatably supported within permanent magnet motor/generator stator 14. Preferably, one or more compliant foil, fluid film, radial, or journal bearings 15A and 15B rotatably support permanent magnet rotor or sleeve 12 and the permanent magnet disposed therein. All bearings, thrust, radial or journal bearings, in turbogenerator 1 may be fluid film bearings or compliant foil bearings. Motor/generator housing 16 encloses stator heat exchanger 17 having a plurality of radially extending stator cooling fins 18. Stator cooling fins 18 connect to or form part of stator 14 and extend into annular space 10A between motor/generator housing 16 and stator 14. Wire windings 14W exist on permanent magnet motor/generator stator 14.

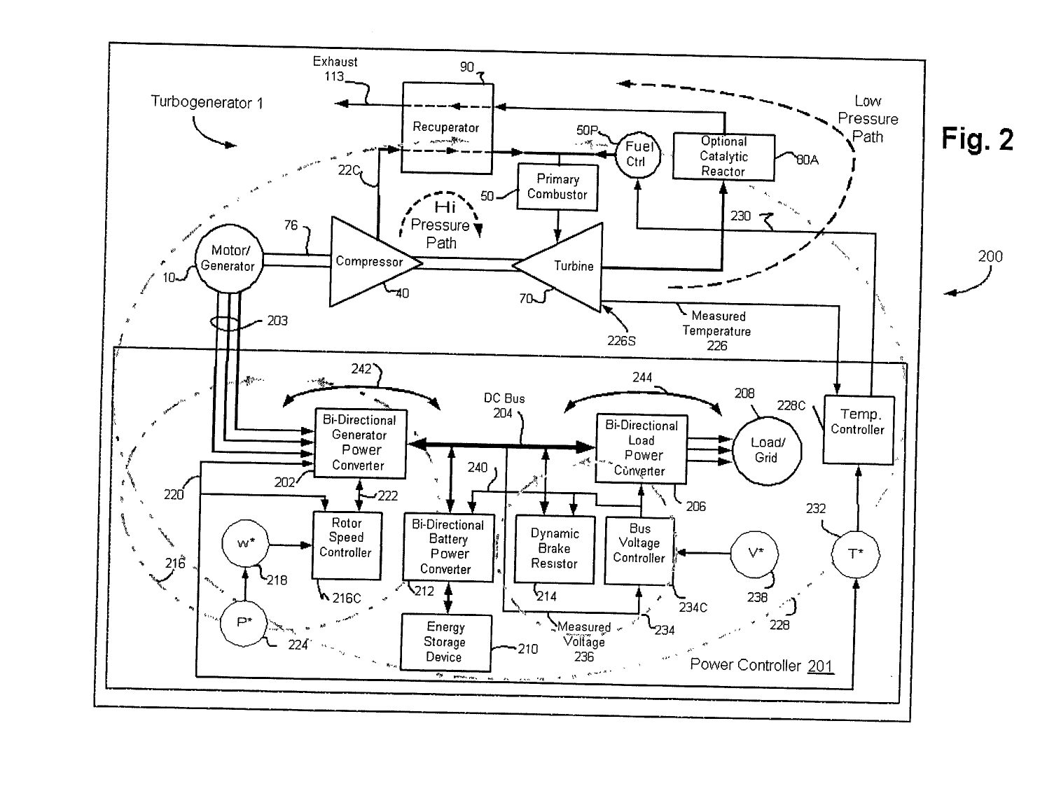

Referring now to FIG. 1D, combustor 50 may include cylindrical inner wall 52 and cylindrical outer wall 54. Cylindrical outer wall 54 may also include air inlets 55. Cylindrical walls 52 and 54 define an annular interior space 50S in combustor 50 defining an axis 50A. Combustor 50 includes a generally annular wall 56 further defining one axial end of the annular interior space of combustor 50. Associated with combustor 50 may be one or more fuel injector inlets 58 to accommodate fuel injectors which receive fuel from fuel control element 50P as shown in FIG. 2, and inject fuel or a fuel air mixture to interior of 50S combustor 50. Inner cylindrical surface 53 is interior to cylindrical inner wall 52 and forms exhaust duct 59 for turbine 70.

Turbine 70 may include turbine wheel 72. An end of combustor 50 opposite annular wall 56 further defines an aperture 71 in turbine 70 exposed to turbine wheel 72. Bearing rotor 74 may include a radially extending thrust bearing portion, bearing rotor thrust disk 78, constrained by bilateral thrust bearings 78A and 78B. Bearing rotor 74 may be rotatably supported by one or more journal bearings 75 within center bearing housing 79. Bearing rotor thrust disk 78 at the compressor end of bearing rotor 74 is rotatably supported preferably by a bilateral thrust bearing 78A and 78B. Journal or radial bearing 75 and thrust bearings 78A and 78B may be fluid film or foil bearings.

Turbine wheel 72, bearing rotor 74 and compressor impeller 42 may be mechanically constrained by tie bolt 74B, or other suitable technique, to rotate when turbine wheel 72 rotates. Mechanical link 76 mechanically constrains compressor impeller 42 to permanent magnet rotor or sleeve 12 and the permanent magnet disposed therein causing permanent magnet rotor or sleeve 12 and the permanent magnet disposed therein to rotate when compressor impeller 42 rotates.

Referring now to FIG. 1E, compressor 40 may include compressor impeller 42 and compressor impeller housing 44. Recuperator 90 may have an annular shape defined by cylindrical recuperator inner wall 92 and cylindrical recuperator outer wall 94. Recuperator 90 contains internal passages for gas flow, one set of passages, passages 33 connecting from compressor 40 to combustor 50, and one set of passages, passages 97, connecting from turbine exhaust 80 to turbogenerator exhaust output 2.

Referring again to FIG. 1B and FIG. 1C, in operation, air flows into primary inlet 20 and divides into compressor air 22 and motor/generator cooling air 24. Motor/generator cooling air 24 flows into annular space 10A between motor/generator housing 16 and permanent magnet motor/generator stator 14 along flow path 24A. Heat is exchanged from stator cooling fins 18 to generator cooling air 24 in flow path 24A, thereby cooling stator cooling fins 18 and stator 14 and forming heated air 24B. Warm stator cooling air 24B exits stator heat exchanger 17 into stator cavity 25 where it further divides into stator return cooling air 27 and rotor cooling air 28. Rotor cooling air 28 passes around stator end 13A and travels along rotor or sleeve 12. Stator return cooling air 27 enters one or more cooling ducts 14D and is conducted through stator 14 to provide further cooling. Stator return cooling air 27 and rotor cooling air 28 rejoin in stator cavity 29 and are drawn out of the motor/generator 10 by exhaust fan 11 which is connected to rotor or sleeve 12 and rotates with rotor or sleeve 12. Exhaust air 27B is conducted away from primary air inlet 20 by duct 10D.

Referring again to FIG. 1E, compressor 40 receives compressor air 22. Compressor impeller 42 compresses compressor air 22 and forces compressed gas 22C to flow into a set of passages 33 in recuperator 90 connecting compressor 40 to combustor 50. In passages 33 in recuperator 90, heat is exchanged from walls 98 of recuperator 90 to compressed gas 22C. As shown in FIG. 1E, heated compressed gas 22H flows out of recuperator 90 to space 35 between cylindrical inner surface 82 of turbine exhaust 80 and cylindrical outer wall 54 of combustor 50. Heated compressed gas 22H may flow into combustor 54 through sidewall ports 55 or main inlet 57. Fuel (not shown) may be reacted in combustor 50, converting chemically stored energy to heat. Hot compressed gas 51 in combustor 50 flows through turbine 70 forcing turbine wheel 72 to rotate. Movement of surfaces of turbine wheel 72 away from gas molecules partially cools and decompresses gas 5 1D moving through turbine 70. Turbine 70 is designed so that exhaust gas 107 flowing from combustor 50 through turbine 70 enters cylindrical passage 59. Partially cooled and decompressed gas in cylindrical passage 59 flows axially in a direction away from permanent magnet motor/generator section 10, and then radially outward, and then axially in a direction toward permanent magnet motor/generator section 10 to passages 97 of recuperator 90, as indicated by gas flow arrows 108 and 109 respectively.

In an alternate embodiment of the present disclosure, low pressure catalytic reactor 80A may be included between fuel injector inlets 58 and recuperator 90. Low pressure catalytic reactor 80A may include internal surfaces (not shown) having catalytic material (e.g., Pd or Pt, not shown) disposed on them. Low pressure catalytic reactor 80A may have a generally annular shape defined by cylindrical inner surface 82 and cylindrical low pressure outer surface 84. Unreacted and incompletely reacted hydrocarbons in gas in low pressure catalytic reactor 80A react to convert chemically stored energy into additional heat, and to lower concentrations of partial reaction products, such as harmful emissions including nitrous oxides (NOx).

Gas 110 flows through passages 97 in recuperator 90 connecting from turbine exhaust 80 or catalytic reactor 80A to turbogenerator exhaust output 2, as indicated by gas flow arrow 112, and then exhausts from turbogenerator 1, as indicated by gas flow arrow 113. Gas flowing through passages 97 in recuperator 90 connecting from turbine exhaust 80 to outside of turbogenerator 1 exchanges heat to walls 98 of recuperator 90. Walls 98 of recuperator 90 heated by gas flowing from turbine exhaust 80 exchange heat to gas 22C flowing in recuperator 90 from compressor 40 to combustor 50.

Turbogenerator 1 may also include various electrical sensor and control lines for providing feedback to power controller 201 and for receiving and implementing control signals as shown in FIG. 2.

Alternative Mechanical Structural Embodiments of the Integrated Turbogenerator

The integrated turbogenerator disclosed above is exemplary. Several alternative structural embodiments are known.

In one alternative embodiment, air 22 may be replaced by a gaseous fuel mixture. In this embodiment, fuel injectors may not be necessary. This embodiment may include an air and fuel mixer upstream of compressor 40.

In another alternative embodiment, fuel may be conducted directly to compressor 40, for example by a fuel conduit connecting to compressor impeller housing 44. Fuel and air may be mixed by action of the compressor impeller 42. In this embodiment, fuel injectors may not be necessary.

In another alternative embodiment, combustor 50 may be a catalytic combustor.

In still another alternative embodiment, geometric relationships and structures of components may differ from those shown in FIG. 1A. Permanent magnet motor/generator section 10 and compressor/combustor section 30 may have low pressure catalytic reactor 80A outside of annular recuperator 90, and may have recuperator 90 outside of low pressure catalytic reactor 80A. Low pressure catalytic reactor 80A may be disposed at least partially in cylindrical passage 59, or in a passage of any shape confined by an inner wall of combustor 50. Combustor 50 and low pressure catalytic reactor 80A may be substantially or completely enclosed with an interior space formed by a generally annularly shaped recuperator 90, or a recuperator 90 shaped to substantially enclose both combustor 50 and low pressure catalytic reactor 80A on all but one face.

An integrated turbogenerator is a turbogenerator in which the turbine, compressor, and generator are all constrained to rotate based upon rotation of the shaft to which the turbine is connected. The methods and apparatus disclosed herein are preferably but not necessarily used in connection with a turbogenerator, and preferably but not necessarily used in connection with an integrated turbogenerator.

Control System

Referring now to FIG. 2, a preferred embodiment is shown in which a turbogenerator system 200 includes power controller 201 which has three substantially decoupled control loops for controlling (1) rotary speed, (2) temperature, and (3) DC bus voltage. A more detailed description of an appropriate power controller is disclosed in U.S. patent application Ser. No. 09/207,817, filed Dec. 8, 1998 in the names of Gilbreth, Wacknov and Wall, and assigned to the assignee of the present application which is incorporated herein in its entirety by this reference.

Referring still to FIG. 2, turbogenerator system 200 includes integrated turbogenerator 1 and power controller 201. Power controller 201 includes three decoupled or independent control loops.

A first control loop, temperature control loop 228, regulates a temperature related to the desired operating temperature of primary combustor 50 to a set point, by varying fuel flow from fuel control element 50P to primary combustor 50. Temperature controller 228C receives a temperature set point, T*, from temperature set point source 232, and receives a measured temperature from temperature sensor 226S connected to measured temperature line 226. Temperature controller 228C generates and transmits over fuel control signal line 230 to fuel pump 50P a fuel control signal for controlling the amount of fuel supplied by fuel pump 50P to primary combustor 50 to an amount intended to result in a desired operating temperature in primary combustor 50. Temperature sensor 226S may directly measure the temperature in primary combustor 50 or may measure a temperature of an element or area from which the temperature in the primary combustor 50 may be inferred.

A second control loop, speed control loop 216, controls speed of the shaft common to the turbine 70, compressor 40, and motor/generator 10, hereafter referred to as the common shaft, by varying torque applied by the motor generator to the common shaft. Torque applied by the motor generator to the common shaft depends upon power or current drawn from or pumped into windings of motor/generator 10. Bi-directional generator power converter 202 is controlled by rotor speed controller 216C to transmit power or current in or out of motor/generator 10, as indicated by bi-directional arrow 242. A sensor in turbogenerator 1 senses the rotary speed on the common shaft and transmits that rotary speed signal over measured speed line 220. Rotor speed controller 216 receives the rotary speed signal from measured speed line 220 and a rotary speed set point signal from a rotary speed set point source 218. Rotary speed controller 216C generates and transmits to generator power converter 202 a power conversion control signal on line 222 controlling generator power converter 202's transfer of power or current between AC lines 203 (i.e., from motor/generator 10) and DC bus 204. Rotary speed set point source 218 may convert to the rotary speed set point a power set point P* received from power set point source 224.

A third control loop, voltage control loop 234, controls bus voltage on DC bus 204 to a set point by transferring power or voltage between DC bus 204 and any of (1) Load/Grid 208 and/or (2) energy storage device 210, and/or (3) by transferring power or voltage from DC bus 204 to dynamic brake resistor 214. A sensor measures voltage DC bus 204 and transmits a measured voltage signal over measured voltage line 236. Bus voltage controller 234C receives the measured voltage signal from voltage line 236 and a voltage set point signal V* from voltage set point source 238. Bus voltage controller 234C generates and transmits signals to bi-directional load power converter 206 and bi-directional battery power converter 212 controlling their transmission of power or voltage between DC bus 204, load/grid 208, and energy storage device 210, respectively. In addition, bus voltage controller 234 transmits a control signal to control connection of dynamic brake resistor 214 to DC bus 204.

Power controller 201 regulates temperature to a set point by varying fuel flow, adds or removes power or current to motor/generator 10 under control of generator power converter 202 to control rotor speed to a set point as indicated by bi-directional arrow 242, and controls bus voltage to a set point by (1) applying or removing power from DC bus 204 under the control of load power converter 206 as indicated by bidirectional arrow 244, (2) applying or removing power from energy storage device 210 under the control of battery power converter 212, and (3) by removing power from DC bus 204 by modulating the connection of dynamic brake resistor 214 to DC bus 204.

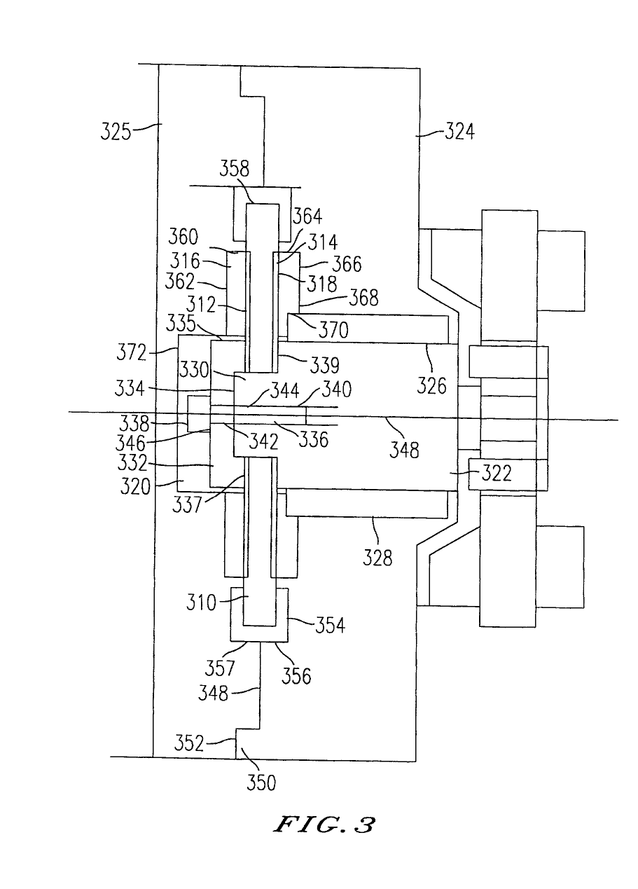

Referring now to FIG. 3, the rotating impeller disc 310 of a rotating compressor is utilized as a thrust bearing (air film type) by clamping formed compliant foil member 312 on one side and formed compliant foil member 314 on the other side of rotating impeller disc 310 causing foils 312 and 314 to rotate with the impeller disc 310 and relative to fixed bearing surface 316 on one side and fixed bearing surface 318 on the other side of impeller disc 310. The rotating impeller/foil assembly is then caused to be centered within compression chamber 320 due to the equalized air film pressure buildup on either side of impeller disc 310 with no other external axial alignment device required. The impeller/foil assembly is integrated as a component of motor shaft 322 rotatably supported on radial air bearings.

Referring further to FIG. 3, motor shaft 322 is supported in housing section 324 by one set of radial air bearings 328. Motor shaft 322 has larger diameter portion 326 engaging radial air bearings 328 and smaller diameter portion 330 supporting impeller disc 310 and foil members 312 and 314.

Referring further to FIG. 3, clamp 332 has cylindrical recess 334 that fits over smaller diameter motor shaft portion 330. Clamp 332 has an outer cylindrical surface 335 that has a diameter substantially equal to larger diameter motor shaft portion 326. Clamp face 337 on clamp 332 extends substantially radially between outer substantially cylindrical surface 335 and recess 334. Motor shaft face 339 of motor shaft 322 extends substantially radially from smaller diameter motor shaft portion 330 to larger diameter motor shaft portion 326. Clamp face 337 of clamp 332 presses foil member 312, impeller disc 310, and foil member 314 against motor shaft face 339.

Clamp 332 is held in place by bolt 336. Bolt 336 has head 338 at one end and male threads 340 at the other end. Bolt 336 passes through hole 342 in clamp 332 and is threaded into internally threaded opening 344 in smaller diameter motor shaft portion 330. As shown, internally threaded opening 344 extends axially along motor shaft 322, and it is centered with respect to axial center line 348 of motor shaft 322. Head 338 of bolt 336 engages outside 346 of clamp 332 to maintain the clamp 332 in place. Clamp 332 could be held on motor shaft 322 by two or more suitable spaced bolts, if desired.

Referring still further to FIG. 3, motor shaft 322, impeller disc 310, foil members 312 and 314, clamp 332, and bolt 336 are enclosed within housing sections 324 and 325. The housing sections can be held together by suitable fasteners (not shown). Interface 348 between housing section 324 and housing section 325 defines compression chamber 320 filled with a fluid (such as air, natural gas, or LPG) that envelopes foil members 312 and 314 and impeller disc 310. Interface 348 includes alignment projection 350 on housing section 324 that mates with corresponding notch 352 in housing section 325. Interface 348 further includes annular enclosure 354 formed by ring shaped recess 356 in housing section 324 and ring shaped recess 357 in housing section 325. Outer portion 358 of impeller disc 310 extends radially outward into enclosure 354. Radially inward of enclosure 354, surface 360 of housing section 325 circumferentially retains bearing surface 316 and surface 362 of housing section 325 radially retains bearing surface 316 adjacent foil member 312. Likewise, radially inward of enclosure 354, surface 364 of housing section 324 circumferentially retains bearing surface 318 and surface 366 of housing section 324 radially retains bearing surface 318 adjacent foil member 314. Notch 368 on the side of bearing surface element 318 facing housing section 324 receives one end 370 of the set of radial air bearings 328. Central recess 372 in housing section 325 accommodates clamp 332 and bolt head 336.

During operation, rotation of impeller disc 310 and attached foil members 312 and 314 drag a layer of fluid along on the surface of the foil members adjacent the bearing surfaces 316 and 318 to provide a fluid layer between foil member 312 and bearing surface 316 and a fluid layer between foil member 314 and bearing surface 318. The fluid layers provide a self-centering function for the impeller/foil assembly. That is, if the impeller/foil assembly moves closer to the bearing surface 316, the fluid pressure between bearing surface 316 and foil member 312 becomes higher than the fluid pressure between the foil member 314 and the bearing surface 318. The higher pressure between the bearing surface 316 and foil member 312 forces the impeller/foil assembly toward bearing surface 318 to equalize the pressure on each side of the impeller/foil assembly. Likewise, if the impeller/foil assembly moves closer to the bearing surface 318, the higher pressure created between bearing surface 318 and foil member 314 forces the impeller/foil assembly back toward the bearing surface 316 to equalize the pressure on each side of the impeller/foil assembly.

Attachment of the foil members to the impeller, rather than to the stationary surfaces abutting the impeller, permits the impeller to be manufactured from softer, lighter and less expensive materials that otherwise could be used. Whereas the housing is preferably constructed of a hard material such as a steel allow, with the use of the preferred system described herein the impeller may be fabricated of a softer, lighter less expensive material such as aluminum or an aluminum alloy. Hence the impeller may be made of a material that is lighter, softer and less expensive than the material from which the associated non-rotating thrust bearing surfaces are fabricated.

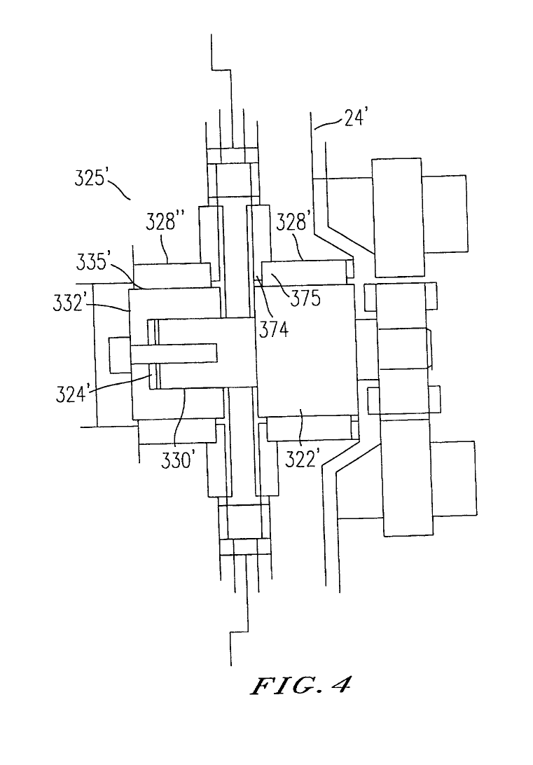

Referring now to FIG. 4, the structure shown corresponds to that shown in FIG. 3 except that motor shaft 322′ is shown supported in two sets of radial air bearings 328′ and 328″. Bearing set 328′ is mounted in housing section 324′. Bearing set 328″ is mounted in housing section 325′ and engages the outer substantially cylindrical surface 335′ of clamp 332′. In this embodiment, smaller diameter motor shaft portion 330′ may be longer than smaller diameter motor shaft portion 330 of FIG. 3 and correspondingly recess 334′ in clamp 332′ is deeper than the corresponding recess 334 in clamp 332. Notch 374 in bearing surface 316′ receives one end 375 of the air bearing set 328′.

The direct drive impeller motor assembly can be contained with a closed chamber housing structure (not shown).

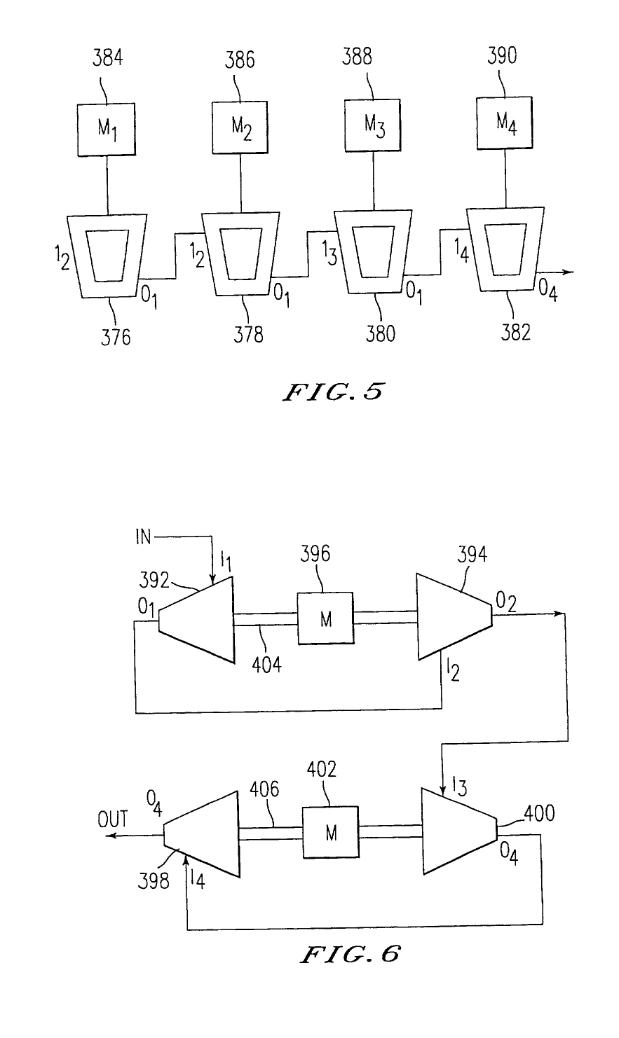

Referring now to FIG. 5, a multi-stage compressor utilizing the above-discussed concept is shown. In this embodiment, each compressor stage 376, 378, 380, and 382 is driven by a separate motor. That is, compressor stages 376, 378, 380, and 382 are driven by motors 384, 386, 388, and 390, respectively, so that the speed of the various compressor stages can be controlled separately providing improved control and performance. Each compressor stage is contained within a separate chamber eliminating leakage between compressor stages to improve performance.

Referring now to FIG. 6, another alternative multi-stage compressor utilizing the above-discussed concept is illustrated. In this embodiment, first compressor stage 392 and second compressor stage 394 are driven by motor 396 and third compressor stage 398 and fourth compressor stage 400 are driven by motor 402 so that speed of the first and second stages can be controlled separately from that of stages three and four, providing improved control and performance over a single-motor system. In this embodiment, first compressor stage 392 is mounted back-to-back with second compressor stage 394 on motor shaft 404 and third compressor stage 398 is mounted back-to-back with fourth compressor stage 400 on motor shaft 406. By mounting first compressor stage 392 back-to-back with second compressor stage 394, the thrust force generated by the first compressor stage is balanced or nearly balanced by the thrust force generated by the second compressor stage. Likewise, the thrust force generated by third compressor stage 398 is balanced or nearly balanced by the thrust forces generated by the fourth compressor stage 400. By balancing the thrust forces in this manner, wear and tear on the compressors may be reduced and compressor life extended. As with the embodiment shown in FIG. 5, each stage is preferably contained within a separate chamber, eliminating leakage between stages to improve performance.

In a preferred embodiment, the action of the compliant foil members located on either side of the impeller disc also serves to form a seal, enhancing the performance of the compressor by reducing leakage across the face of the impeller disc.

Having now described the invention in accordance with the requirements of the patent statutes, those skilled in this art will understand how to make changes and modifications in the present invention to meet their specific requirements or conditions. For example, while the impeller disc with attached rotating compliant foil fluid film bearings has been particularly described as preferably used with a compressor, it should be recognized that the concepts discussed herein are applicable to any rotating machine that can utilize or require a thrust disc with attached rotating compliant foil members. Such changes and modifications may be made without departing from the scope and spirit of the invention as set forth in the following claims.

What is claimed is:

1. A compliant foil fluid film thrust bearing comprising:
(a) a thrust disc rotatably supported between a first non-rotating thrust bearing surface and a second non-rotating thrust bearing surface;
(b) a first compliant foil member operably disposed between said thrust disc and said first of non-rotating thrust bearing surface;
(c) a second compliant foil member operably disposed between said thrust disc and said second thrust bearing surface ; and
(d) mounting structure that attaches said first compliant foil member and said second compliant foil member on opposing surfaces of said thrust disc for rotation therewith.

2. A compliant foil fluid film thrust bearing according to claim 1, further comprising:
(a) a rotatable shaft supporting said thrust disc; and
(b) wherein said mounting structure comprises a clamp mounting said first compliant foil member, said thrust disc, and said second compliant foil member to said shaft.

3. A compliant foil fluid film thrust bearing according to claim 2, wherein
(a) said shaft comprises a smaller diameter section and a larger diameter section; and
(b) said clamp mounts said first foil member, said thrust disc, and said second foil member on said smaller diameter section of said shaft.

4. A compliant foil fluid film thrust bearing according to claim 3, wherein said shaft includes a first radially extending face extending between said smaller diameter section and said larger diameter section of said shaft, said clamp pressing said first foil member, said thrust disc, and said second foil member against said first radially extending face.

5. A compliant foil fluid film thrust bearing according to claim 4, wherein said clamp includes a recess shaped to receive said smaller diameter section of said shaft and said clamp further includes a second radially extending face pressing said first foil member, said thrust disc, and said second foil member against said first radially extending face.

6. A compliant foil fluid film thrust bearing according to claim 5, further comprising a bolt securing said clamp to said shaft.

7. A compliant foil fluid film thrust bearing according to claim 6, further comprising:
(a) a first housing section;
(b) a second housing section attached to said first housing section along an interface defining an enclosure; and
(c) wherein said first foil member, said thrust disc, and said second foil member are mounted for rotation within said enclosure.

8. A compliant foil fluid film thrust bearing according to claim 7, further comprising:
(a) a fluid within said enclosure; and
(b) wherein during rotation said fluid maintains said first foil member, said thrust disc, and said second foil member approximately axially centered within said enclosure.

9. A compliant foil fluid film thrust bearing according to claim 8, further comprising a first set of radial air bearings rotatably supporting said shaft within said first housing section.

10. A compliant foil fluid film thrust bearing according to claim 9, further comprising a second set of radial air bearings in said second housing section rotatably supporting said shaft within said second housing section.

11. The compliant foil fluid film thrust bearing of claim 1 wherein said thrust disk comprises aluminum.

12. The compliant foil fluid film thrust bearing of claim 1 wherein said thrust disk is made of a metal alloy that is lighter than steel.

13. The compliant foil fluid film thrust bearing of claim 1 wherein said thrust disk is made of a metal alloy that is softer than steel.

14. The compliant foil fluid film thrust bearing of claim 1 wherein said thrust disk is made of a material that is lighter and softer than the material from which said first and second non-rotating thrust bearing surfaces are made.

15. A turbomachine comprising:
(a) a thrust disc rotatably supported on a shaft between a first non-rotating thrust bearing surface and a second non-rotating thrust bearing surface;
(b) a first compliant foil member clamped ajacent to a first face of said thrust disc, between said first face and said first non-rotating thrust bearing surface, for rotation with said thrust disc; and
(c) a second compliant foil member clamped adjacent to a second face of said thrust disc, between said second face and said second non-rotating thrust bearing surface, for rotation with said thrust disc.

16. The turbomachine of claim 15 wherein said shaft comprises sections having different diameters and said first and second compliant foil members are clamped to said thrust disc around a section of said shaft having a smaller diameter than another section of said shaft.

17. The turbomachine of claim 15 wherein said shaft includes a radially extending face extending between a smaller diameter section and a larger diameter section of said shaft, and wherein said said first foil member, said thrust disc, and said second foil member, are clamped against said radially extending face.

18. The turbomachine of claim 15 further comprising a bolt that secures a clamp, said first and second compliant foil members, and said thrust disc, to said shaft.

19. The turbomachine of claim 15 wherein said thrust disc and said first and second compliant foil members are enclosed within a housing.

20. The turbomachine of claim 15 wherein:
(a) said housing contains a fluid; and
(b) forces generated by the rotation of said first and second foil members in proximity to said fluid maintains said thrust disc approximately centered between said first and second non-rotating thrust bearing surfaces.

21. The turbomachine of claim 15 further comprising radial air bearings rotatably supporting said shaft.

22. The turbomachine of claim 15 further comprising a plurality of radial air bearings rotatably supporting said shaft within said housing.

23. The turbomachine of claim 15 wherein said thrust disc is an impeller disc of a rotating compressor.

24. The turbomachine of claim 15 further comprising a plurality of compressor stages and wherein each of said compressor stages comprises a compressor that itself comprises at least one of said thrust discs and at least one pair of said first and second compliant foil members.

25. The turbomachine of claim 24 adapted so that the speed of each of said pluality of compressor stages can be controlled independently of the other.

26. The turbomachine of claim 24 further comprising at least two compressors mounted on said shaft.

27. The turbomachine of claim 24 further comprising a pair of compressors mounted back-to-back on said shaft.

28. The turbomachine of claim 15 in which at least one of said compliant foil members serves as a seal against leakage across the face of the thrust disc.

29. The turbomachine of claim 15 in which said turbomachine is a turbogenerator.

30. The turbomachine of claim 29 further adapted to generate power for rotating said thrust disk using a catalytic reactor and a recuperated cycle.

31. The turbomachine of claim 15 wherein said thrust disk is made of a material that is softer or lighter than steel.

32. The compliant foil fluid film thrust bearing of claim 1 wherein said thrust disk is made of a material that is lighter than the material from which at least one of said first or second non-rotating thrust bearing surfaces is made.

33. A method of making a compliant foil fluid film thrust bearing comprising the steps of:
(a) rotatably supporting a thrust disc between a first non-rotating thrust bearing surface and a second non-rotating thrust bearing surface;
(b) operably disposing a first compliant foil member between said thrust disc and said first thrust bearing surface;
(c) operably disposing a second compliant foil member between said thrust disc and said second thrust bearing surface; and
(d) mounting said first compliant foil member and said second compliant foil member to said thrust disc for rotation therewith.

34. A method of making a compliant foil fluid film thrust bearing according to claim 33, further comprising the steps of:
(a) providing a rotatable shaft supporting said thrust disc; and
(b) clamping said first compliant foil member, said thrust disc, and said second compliant foil member to said shaft.

35. A method of making a compliant foil fluid film thrust bearing according to claim 33, further comprising the steps of:
(a) providing a smaller diameter section and a larger diameter section on said shaft;
(b) clamping said first foil member, said thrust disc, and said second foil member on said smaller diameter section of said shaft.

36. A method of making a compliant foil fluid film thrust bearing according to claim 33, further comprising the steps of:
(a) providing said shaft with a first radially extending face extending between said smaller diameter section and said larger diameter section; and
(b) said clamping step comprises pressing said first foil member, said thrust disc, and said second foil member against said first radially extending face.

37. A method of making a compliant foil fluid film thrust bearing according to claim 33, further comprising the steps of:
(a) providing a clamp with a recess shaped to receive the small diameter section of said shaft; and
(b) providing said clamp with a second radially extending face pressing said first foil member, said thrust disc, and said second foil member against said first radially extending face.

38. A method of making a compliant foil fluid film thrust bearing according to claim 5, further comprising the step of tightening a bolt to secure said clamp to said shaft.

39. A method of making a turbomachine containing a compliant foil fluid film thrust bearing according to claim 2 comprising the steps of:
(a) providing a first housing section;
(b) providing a second housing section attached to said first housing section along an interface defining an enclosure; and
(c) mounting said first foil member, said thrust disc, and said second foil member for rotation within said enclosure.

40. The method claim 33, further comprising the step of providing a fluid within said enclosure maintaining said first foil member, said thrust disc, and said second foil member approximately axially centered within said enclosure during rotation thereof.

41. The method of claim 34, further comprising the step of providing a first set of radial air bearings rotatably supporting said shaft within said first housing section.

42. The method of claim 35, further comprising the step of providing a second set of radial air bearings in said second housing section rotatably supporting said shaft within said second housing section.

43. A compliant foil fluid film thrust bearing comprising:
(a) first means for resisting thrust forces rotatably supported between a first non-rotating thrust bearing means and a second non-rotating thrust bearing means;
(b) a first compliant foil means operably disposed between said first means and said first non-rotating thrust bearing means;
(c) a second compliant foil means operably disposed between said first means and said second thrust bearing means; and
(d) second means for mounting said first compliant foil means and said second compliant foil means on said first means for rotation therewith.

44. A method of using a compliant foil fluid thrust bearing comprising the steps of
(a) mounting a rotatable thrust disc between a first non-rotating thrust bearing surface and a second non-rotating thrust bearing surface;
(b) operably disposing a first compliant foil member between said thrust disc and said first thrust bearing surface;
(c) operably disposing a second compliant foil member between said thrust disc and said second thrust bearing surface;
(d) mounting said first compliant foil member and said second compliant foil member to said thrust disc; and
(e) rotating said first compliant foil member, said second compliant foil member, and said thrust disc together with respect to said first thrust bearing surface and said second thrust bearing surface.

45. A method for laterally stabilizing a thrust disc rotatably supported on a shaft between a first non-rotating thrust bearing surface and a second non-rotating thrust bearing surface comprising:
(a) clamping a first compliant foil disc onto a first face of said thrust disc between said first face and said first non-rotating thrust bearing surface; and
(b) clamping a second compliant foil disc onto a second face of said thrust disc between said second face and said second non-rotating thrust bearing surface.

46. The method of claim 45 wherein:
(a) said shaft comprises a smaller diameter section and a larger diameter section; and
(b) said first and second compliant foil discs and said thrust disc are mounted on said smaller diameter section of said shaft.

47. The method of claim 45 wherein said thrust disk is made of a material that is lighter than the material from which at least one of said first or second non-rotating thrust bearing surfaces is made.
